(19) United States
(12) Patent Application Publication
(10) Pub. No.: US 2011/0150388 A1
(43) Pub. Date: Jun. 23, 2011

(54) OPTICAL SWITCH USING MACH-ZEHNDER INTERFEROMETER AND OPTICAL SWITCH MATRIX HAVING THE SAME

(75) Inventors: Jang Uk SHIN, Daejeon (KR); Young Tak Han, Daejeon (KR); Sang Ho Park, Daejeon (KR); Sang-Pil Han, Daejeon (KR); Yongsoon Baek, Daejeon (KR)

(73) Assignee: ELECTRONICS AND TELECOMMUNICATIONS RESEARCH INSTITUTE, Daejeon (KR)

(21) Appl. No.: 12/959,880

(22) Filed: Dec. 3, 2010

(30) Foreign Application Priority Data
Dec. 18, 2009 (KR) 10-2009-0127235

(51) Int. Cl. G02B 6/35

(52) U.S. Cl. 385/16

(57) ABSTRACT

Provided are an optical switch using a Mach-Zehnder interferometer and an optical switch matrix including the same. The optical switch includes a first coupler, an optical delay line, and a second coupler. The first coupler branches an optical signal transmitted to a first or second input waveguide into two optical signals. The optical delay line includes first and second arm waveguides of the same length transmitting the branched optical signal and a heater heating the first arm waveguide. The first and second arm waveguides have one of a full wavelength optical path difference and a half wavelength optical path difference according to whether the heater is turned on. The second coupler branches optical signals outputted from the optical delay line into two optical signals, respectively, and transmits the branched optical signals to the first or second output waveguide.

### CROSS-REFERENCE TO RELATED APPLICATIONS

This U.S. non-provisional patent application claims priority under 35 U.S.C. §119 of Korean Patent Application No. 10-2009-0127235, filed on Dec. 18, 2009, the entire contents of which are hereby incorporated by reference.

### BACKGROUND OF THE INVENTION

The present invention disclosed herein relates to an optical switch using a Mach-Zehnder interferometer and an optical switch matrix including the same.

An optical switch is a device allowing input optical signals to be coupled to a desired path using external control signals. Examples of the optical switch structures include directional coupler switches, Mach-Zehnder interferometric switches, and Y-branch optical switches.

The directional coupler switches are devices switching paths of optical waves by controlling a coupling phenomenon between two adjacent optical waveguides using external control signals. The Mach-Zehnder interferometric switches may switch paths by controlling a relative phase difference of optical waves passing different paths using external signals. The Y-branch optical switches may switch paths using a mode evolution phenomenon of optical waves generated in branched regions. The mode evolution phenomenon refers to a phenomenon that the local normal mode distribution may vary according to changes of structure at each location of the branched optical waveguide structure that is changed according to the traveling direction of optical waves.

### SUMMARY OF THE INVENTION

The present invention provides an optical switch and an optical switch matrix including the same, which has excellent loss characteristics or extinction characteristics.

Embodiments of the present invention provide optical switches including: a first coupler branching an optical signal transmitted to a first or second input waveguide into two optical signals; an optical delay line including first and second arm waveguides of the same length transmitting the branched optical signal and a heater heating the first arm waveguide, the first and second arm waveguides having one of a full wavelength optical path difference and a half wavelength optical path difference according to whether the heater is turned on; and a second coupler branching optical signals outputted from the optical delay line into two optical signals, respectively, and transmitting the branched optical signals to the first or second output waveguide.

In some embodiments, the first coupler, the second coupler, and the optical delay line may be configured with one Mach-Zehnder interferometer. In other embodiments, the first arm waveguide transmits one of the branched optical signals from the first coupler and outputs the transmitted the one of the branched optical signals to the second coupler, and the second arm waveguide transmits the other of the branched optical signals and outputs the transmitted the other of the branched optical signals to the second coupler.

In still other embodiments, the optical delay line may have the half wavelength optical path difference when the heater is turned off, and have the full wavelength optical path difference when the heater is turned on.

In even other embodiments, the first arm waveguide may include a first portion, and the second arm waveguide may include a second portion corresponding to the first portion. The first portion may have a width smaller than that of the second portion.

In yet other embodiments, the heater may heat the first portion directly.

In further embodiments, the optical signal inputted to the first or second input waveguide may be outputted in a straight state when the heater is turned on.

In still further embodiments, the optical signal inputted to the first or second input waveguide may be outputted in a cross state when the heater is turned off.

In even further embodiments, the first output waveguide and the second output waveguide may cross each other.

In yet further embodiments, the half wavelength optical path difference may be generated according to mechanical processing of the respective first and second arm waveguides.

In yet further embodiments, the half wavelength optical path difference may be generated by a change of the refractive indexes of the respective first and second arm waveguides.

In yet further embodiments, the half wavelength optical path difference may be generated by a change of the width of the respective first and second arm waveguides.

In other embodiments of the present invention, optical switch matrixes include: input waveguides coupled to M (M is an integer greater than 1) input ports, respectively; output waveguides coupled to N (N is an integer greater than 1) input ports, respectively; and optical switches formed with one Mach-Zehnder interferometer at each position where the input waveguides and the output waveguides cross each other, wherein the optical switches include first and second arm waveguides of the same length generating one of a full wavelength optical path difference and a half wavelength optical path difference according to whether a heater is turned on, and the heater heats the first or second arm waveguide.

In some embodiments, when an optical signal inputted to one of the input ports is outputted to one of the output ports, the other output ports except the output ports to which the optical signal is outputted may be blocked out such that optical signals are not outputted to the other output ports, and the optical switch matrix may further include dummy output ports for outputting the optical signals.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a diagram illustrating an optical switch according to an exemplary embodiment of the present invention;

FIG. 2 is a diagram illustrating the switching characteristics of an optical switch of FIG. 1 when there is no fabrication process error;

FIG. 3 is a diagram illustrating the switching characteristics of an optical switch of FIG. 1 when there is a fabrication process error; and

FIG. 4 is a diagram illustrating an exemplary optical switch matrix using an optical switch of FIG. 1.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, it will be described about an exemplary embodiment of the present invention in conjunction with the accompanying drawings.

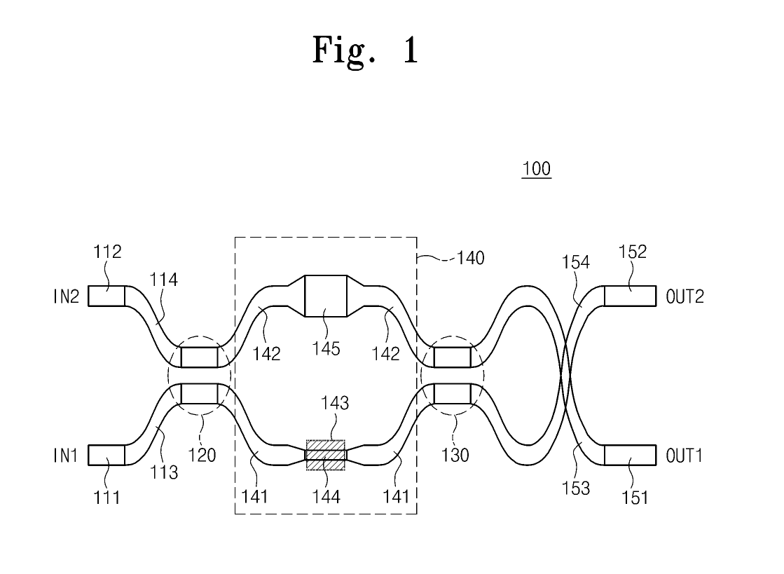

FIG. 1 is a diagram illustrating an optical switch according to an exemplary embodiment of the present invention.

Referring to FIG. 1, an optical switch 100 may include first and second input ports 111 and 112, first and second input waveguides 113 and 114, first and second couplers 120 and 130, an optical delay line 140, first and second output ports 151 and 152, and first and second output waveguides 153 and 154.

The first coupler 120 may branch optical signals inputted to one of the first and second input waveguides 113 and 114, and transmit the branched optical signals to first and second arm waveguides. Here, the branch ratio may be about 0.5. That is, the coupling constant of the first coupler 120 may be about 3 dB.

The second coupler 130 may branch the optical signals transmitted from the first and second arm waveguides 141 and 142, and transmit the branched optical signals to the first and second output waveguides 153 and 154. Here, the branch ratio may be about 0.5. The coupler is called an optical multiplexer/demultiplexer.

The optical delay line 140 may include the first and second arm waveguides 141 and 142, and a heater 143. The optical delay line 140 may allow the optical signals transmitted from the first and second arm waveguides 141 and 142 to have an optical path difference of a half wavelength or a full wavelength.

For example, the optical delay line 140 may allow the optical signals outputted from the first coupler 120 to travel to the first and second arm waveguides 141 and 142 having the same length upon turn-off of the heater 143, generating an optical path difference of a half wavelength. On the other hand, the optical delay line 140 may allow the optical signals outputted from the first coupler 120 to travel to the first and second arm waveguides 141 and 142 having the same length upon turn-on of the heater 143, generating an optical path difference of a full wavelength.

The first arm coupler 141 may be coupled to the first input waveguide 113 through the first coupler 120, and be coupled to the second input waveguide 154 through the second coupler 130. The second arm waveguide 142 may be coupled to the second input waveguide 114 through the first coupler 120, and be coupled to the first input waveguide 153 through the second coupler 130.

The optical path difference of the optical delay line 140 may be generated by changing the refractive index of the first and second arm waveguides 141 and 142. That is, when the refractive index of the waveguides 141 and 142 is changed, the wavelengths travelling the waveguides 141 and 142 may be changed. Thus, the optical path difference may be generated. Particularly, in order to change the refractive index of the first and second arm waveguides 141 and 142, the width of the first and second arm waveguides 141 and 142 may be varied as shown in FIG. 1.

For example, when the width of a first portion 144 of the first arm waveguide 141 is narrower than other regions of the first arm waveguide 141, the refractive index of the first arm waveguide 141 may be lower than the refractive index of a waveguide that is not narrowed. On the other hand, when the width of a second portion 145 of the second arm waveguide 142 is wider than other regions of the second arm waveguide 142, the refractive index of the second arm waveguide 142 may be higher than the refractive index of a waveguide that is not widened. Accordingly, the whole optical path difference of the optical delay line 140 may be determined by adjustment of the width of the first and second portions 144 and 145 of the respective arm waveguides 141 and 142.

In FIG. 1, the first portion 144 may be located at the center of the first arm waveguide 141, and the second portion 145 may be located at the center of the second arm waveguide 142, but embodiments of the present invention are not limited thereto. For example, the first portion 144 of the present invention may be located at any position, and the second portion 145 may be located at any position corresponding to the first portion 144. Here, the first portion 144 and the second portion 145 may be provided at positions corresponding to each other.

The heater 143 may be provided at any position of the first arm waveguide 141. For example, the heater 143 may be located at the center portion of the first arm waveguide 141. In an embodiment, the heater 143 may be implemented to heat the first portion 144 of the first arm waveguide 141. That is, the heater 143 may be implemented to surround the first portion 144 of the first arm waveguide 141.

The heater 143 shown in FIG. 1 may be provided in the first arm waveguide 141, but embodiments of the present invention are not limited thereto. The heater 143 may be provided in at least one of the first and second arm waveguides 141 and 142.

An optical path difference of a half wavelength may be generated in the optical delay line 140 according to whether the heater 143 is driven. For example, when the heater 143 is turned off, the optical delay line 140 may maintain the optical path difference of a half wavelength when the signals having the same phase are inputted. On the other hand, when the heater 143 is turned on, the optical delay line 140 may maintain the optical path difference of a full wavelength as a whole. Here, the optical path difference of a full wavelength may be the sum of an optical path difference of a half wavelength of the optical delay line 140 in a turn-off state and an optical path difference of a half wavelength generated by turn-on.

This is because the refractive index of the first arm waveguide 141 is changed by heating of the heater 143. Upon heating, the refractive index may be increased or reduced according to a material forming the first arm waveguide 141. For example, when the temperature coefficient of the material forming the waveguide is positive, the refractive index may be increased by the heating. On the other hand, when the temperature coefficient of the material forming the waveguide is negative, the refractive index may be reduced by the heating.

The optical delay line 140 may generate an optical path difference of a half wavelength in turn-off state, and generate an optical path difference of a full wavelength in turn-on state.

The optical delay line 140 may generate an optical path difference of a half wavelength using the variation of the refractive index of the first and second arm waveguides, and may generate an optical path difference of a half wavelength by turning on the heater 143. Here, the variation of the refractive index may occur by controlling the width of the first and second arm waveguides 141 and 142 and turning on the heater 143.

Referring again to FIG. 1, the optical switch 100 may allow the first and second output waveguides 153 and 154 to cross each other. Thus, in turn-off state of the heater 143, optical signals inputted to the first input port 111 may be outputted to the second output port 152, and optical signals inputted to the second input port 112 may be outputted to the first output port 151.

On the other hand, in turn-on state of the heater 143, optical signals inputted to the first input port 111 may be outputted to the first output port 151, and optical signals inputted to the second input port 112 may be outputted to the second output port 152.

The optical switch 100 may be implemented in one Mach-Zehnder interferometer. Here, the Mach-Zehnder interferometer may include the first and second couplers 120 and 130 and the optical delay line 140 having the first and second arm waveguides 141 and 142 coupled between the first and second couplers 120 and 130.

The optical switch 100 may control the width of at least one portion of the arm waveguides 141 and 142 to generate an optical path difference in the optical delay line 140, but embodiments of the present invention are not limited thereto. The optical switch 100 may utilize various methods such as a mechanical processing change of waveguides and a change of the refractive index of waveguides to generate an optical path difference.

Generally, the Mach-Zehnder interferometer optical switch may generate a polarization mismatch according to a length difference of a waveguide having birefringence. Thus, undesirable extinction characteristics may be shown.

On the other hand, the optical switch 100 may be configured such that the first and second arm waveguides 141 and 142 have the same length. Thus, although the first and second arm waveguides 141 and 142 have a birefringence, the optical switch 100 may not generate a polarization mismatch. This is because the effect of the birefringence generated from first and second arm waveguides 141 and 142 are offset by each other. Accordingly, the extinction characteristics of the optical switch 100 can be improved.

A typical Mach-Zehnder interferometer optical switch may show undesirable extinction characteristics by a fabrication process error.

However, the optical switch 100 according the embodiment of the present invention can reduce characteristics deterioration by the process error. The reason will be described below. Although there is a fabrication process error of an optical switch, the first and second couplers 120 and 130 of the optical switch 100 may be simultaneously processed. Accordingly, the processed first and second couplers 120 and 130 may have the substantially same characteristics. When the heater 143 is turned on, loss or extinction characteristics deterioration may occur due to the characteristics difference. However, the characteristics difference may not occur between the couplers 120 and 130. Accordingly, the optical switch 100 may have excellent loss or extinction characteristics.

Table 1 shows the characteristics of typical optical switches compared to the optical switch 100 according to the embodiment of the present invention.

TABLE 1

| | | | | Optical |
|---|---|---|---|---|
| | | 1-Step Mach- | 2-Step Mach- | Switch of |
| | | Zehnder Optical | Zehnder Optical | the Present |
| Division | | Switch | Switch | Invention |
| Cross | Loss | Normal | Good | Good |
| | Extinction | Bad | Good | Good |
| Straight | Loss | Normal | Bad | Normal |
| | Extinction | Bad | Good | Bad |

| | |
|---|---|
| Other | Only one side is |
| | straight. |

Here, the cross state means that an first input IN1 inputted to the first input port (111 of FIG. 1) is outputted to the second output port 152 through the optical switch (100 of FIG. 1), or an second input IN2 inputted to the second input port (112 of FIG. 1) is outputted to the first output port 151 through the optical switch (100 of FIG. 1).

The straight state means that the first input IN1 inputted to the first input port (111 of FIG. 1) is outputted to the first output port 151 through the optical switch (100 of FIG. 1), or an second input IN2 inputted to the second input port (112 of FIG. 1) is outputted to the second output port 152 through the optical switch (100 of FIG. 1).

The optical switch 100 according to the embodiment of the present invention may be in cross state when turned off, and may be in straight state when turned on, but embodiments of the present invention are not limited thereto. In another embodiment, the optical switch 100 may be in straight state when turned off, and may be in cross state when turned on.

Referring to FIG. 1, a typical 1-step Mach-Zehnder optical switch may have a normal loss characteristic and a bad extinction characteristic in cross state, and may have a normal loss characteristic and a bad extinction characteristic in straight state.

A typical 2-step Mach-Zehnder optical switch may have a good loss characteristic and a good extinction characteristic in cross state, and may have a bad loss characteristic and a good extinction characteristic in straight state. However, the 2-step Mach-Zehnder optical switch may have a limitation in running straight only at one side.

On the other hand, the optical switch 100 according to the embodiment of the present invention may have a good loss characteristic and a good extinction characteristic in cross state (turn-off), and may have a normal loss characteristic and a bad extinction characteristic in straight state (turn-on).

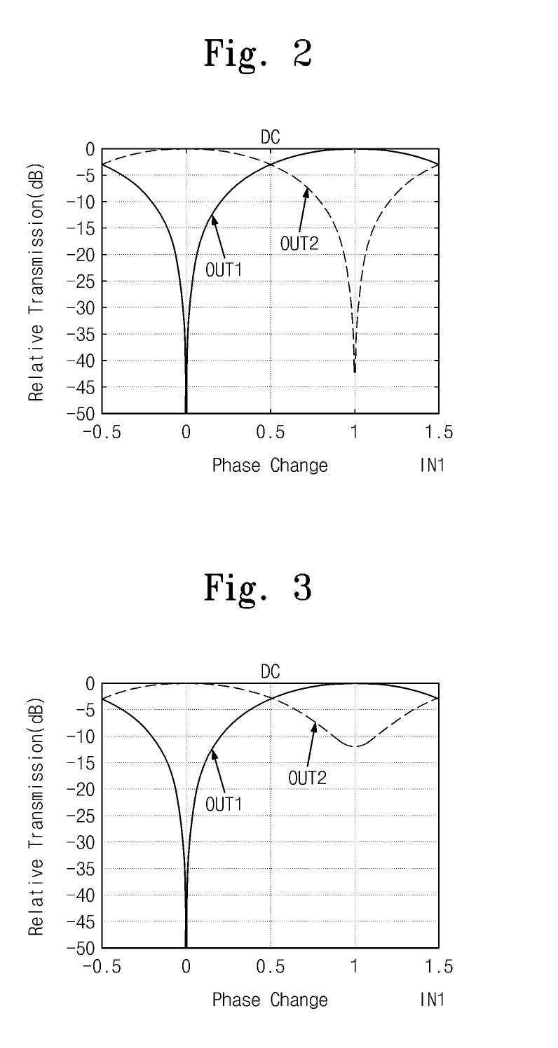

FIG. 2 is a diagram illustrating switching characteristics of an optical switch 100 when there is no fabrication process error. Here, the absence of the fabrication process error means the branch ratio of the first and second couplers 120 and 130 is about 0.5. Referring to FIG. 2, the waveforms of output signals OUT1 and OUT1 are shown when a first input signal IN1 is inputted to the first input port (111 of FIG. 1). In FIG. 2, the vertical axis refers to a transmission rate of an output optical signal with respect to an input optical signal, and the horizontal axis refers to a phase change generated by a heater. For example, when the phase change is 0, the heater (143 of FIG. 1) is in turn-off state. When the phase change is 1, the heater is in turn-on state.

For convenience of explanation, it will be assumed that the optical switch 100 is in cross state when turned off, and is in straight state when turned on.

When the optical switch 100 is turned off, that is, when the heater (143 of FIG. 1) is turned off, the second output OUT2 may be outputted according to the first input IN1. As shown in FIG. 2, there is no phase change in the second output OUT2. In this case, the first output OUT1 may have a transmission rate of about −50 dB or less. That is, the first output OUT1 may be perfectly blocked out. Accordingly, the loss and extinction characteristics are good in cross state.

When the optical switch 100 is turned on (straight state), that is, when the heater 143 is turned on, the first output OUT1 may be outputted according to the first input IN1. As shown in FIG. 2, there is a half wavelength (PI) phase change in the first output OUT1. In this case, the second output OUT2 may have a transmission rate of about −40 dB or less. That is, the second output OUT2 may be perfectly blocked out. Accordingly, the loss and extinction characteristics are good in straight state.

In conclusion, when there is no process error, the optical switch 100 may have good loss and extinction characteristics in both cross and straight states.

FIG. 3 is a diagram illustrating switch characteristics of an optical switch when there is a fabrication process error. Here, the presence of the fabrication process error means that the branch ratio of the first and second couplers 120 and 130 is not 0.5. Referring to FIG. 3, the waveforms of the output signals OUT1 and OUT2 are shown when the first input signal IN1 is inputted to the first input port (111 of FIG. 1).

When the optical switch 100 is turned off, that is, when the heater (143 of FIG. 1) is turned off, the second output OUT2 may be outputted according to the first input IN1. As shown in FIG. 3, there is no phase change in the second output OUT2. In this case, the first output OUT1 may have a transmission rate of about −50 dB or less. That is, the first output OUT1 may be perfectly blocked out. Accordingly, the loss and extinction characteristics are good in cross state.

When the optical switch 100 is turned on (straight state), that is, when the heater (143 of FIG. 1) is turned on, the first output OUT1 may be outputted according to the first input IN1. As shown in FIG. 2, there is a half wavelength (PI) phase change in the first output OUT1. In this case, the second output OUT2 may have a transmission rate between about −10 dB and about −15 dB. That is, the second output OUT2 may not be perfectly blocked out. This means that an optical switch having a process error may have bad extinction characteristics in straight state compared to an optical switch having no process error.

In conclusion, when there is a process error, the optical switch 100 may have good loss and extinction characteristics in cross state, but may have bad loss and extinction characteristics in straight state.

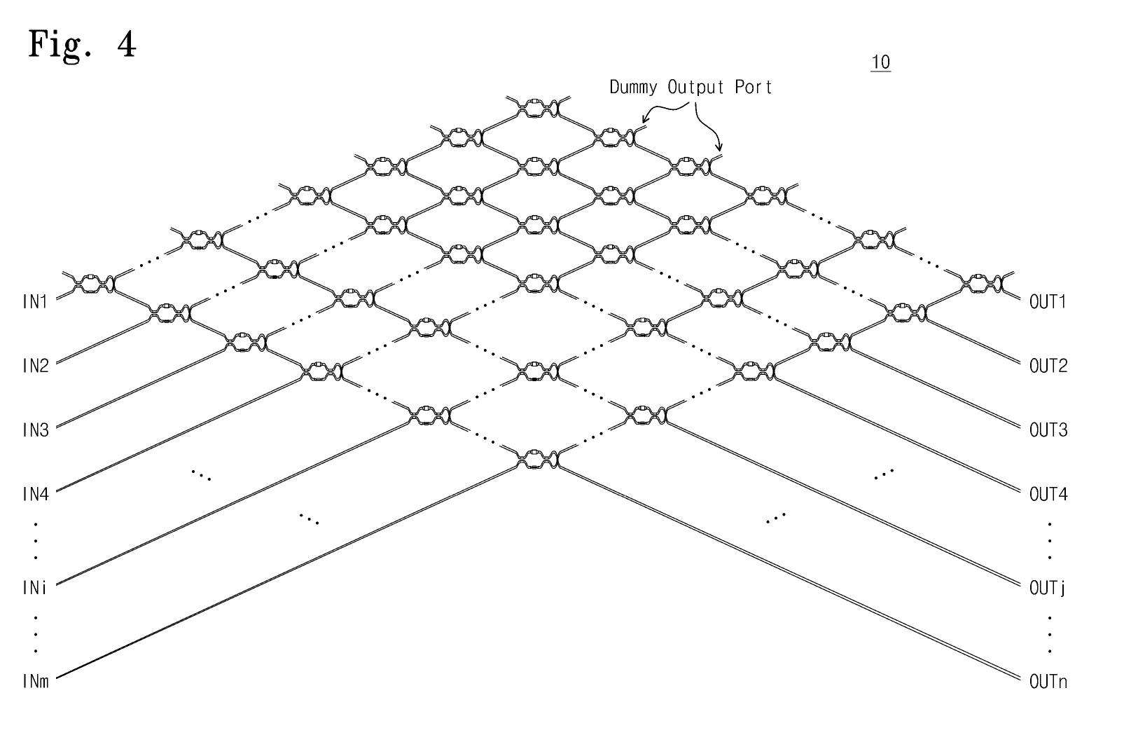

FIG. 4 is a diagram illustrating an exemplary optical switch matrix 10 using an optical switch of FIG. 1. Referring to FIG. 4, the optical switch matrix 10 may include M (an integer is greater than 1) input ports (IN1 to INM) and N output ports (OUT1 to OUTN).

The optical switch matrix 10 according to the embodiment of the present invention may be implemented with an M×N matrix structure including a plurality of optical switches. That is, the optical switch matrix 10 may be implemented with M×N optical switches. Here, the optical switches may be configured similarly to the optical switch 100 shown in FIG. 1, respectively.

Hereinafter, the reason why the loss or extinction characteristics are improved will be described in detail. In order to an optical path from i-th input (i is an integer that is not greater than M) to j-th output (j is an integer that is not greater than N), all optical switches may be turned off. Thus, the optical switch matrix 10 may become cross state. Only a j-th optical switch on an i-th waveguide may be turned on to become straight state.

Accordingly, only one optical switch with respect to each optical path may be turned on to become straight state, and the other optical switches may all be turned off to become cross state. As shown in Table 1, the optical switch according to the embodiment of the present invention may have good extinction and loss characteristics in turn-off state, that is, cross state. Accordingly, most turned-off optical switches do not have a limitation in the loss or extinction characteristics.

On the other hand, the optical switch according to the embodiment of the present invention may have normal loss characteristics and bad extinction characteristics according to a process error in case of optical loss of the turn-on state. However, since optical switch generating optical loss is restricted to one optical switch that is turned on in every path, there is no limitation on the whole.

The optical switch matrix 10 may not generate a extinction limitation. For example, when only a j-th optical switch on an i-th waveguide is turned on to set an optical path from an i-th input to a j-th output, most optical signals may run straight to a direction of a j-th output port. An optical signal toward a j+1-th optical switch in a direction of an i-th input waveguide, which is not blocked out, may proceed to the i-th input waveguide direction to be finally outputted to dummy output ports because all optical switches following the j+1-th optical switch are in turned-off. Thus, there is no actual affect on the output ports.

Accordingly, the optical switch matrix 10 may have good optical loss or extinction characteristics compared to typical optical switches while using a simple Mach-Zehnder interferometer optical switch as a unit switching device.

On the other hand, when a dummy port is used as an output, the optical switch matrix 10 may be implemented with add-drop switches.

The optical switch matrix 10 may be easily applied to typical plane optical waveguides like in a silica plane waveguide process and a polymer plane waveguide process.

An optical switch according to an embodiment of the present invention allows the loss characteristics or extinction characteristics to be improved even when one Mach-Zehnder interferometer is used. Also, an optical switch matrix can simplify the disposition of an optical switch and design of a waveguide, and can reduce optical loss.

As described above, optical switches according to embodiments of the present invention can improve loss or extinction characteristics even when one Mach-Zehnder interferometer is used, by including an optical delay line generating an optical length difference of a half wavelength by changing the refractive index and maintaining the same length.

Also, optical switches according to embodiments of the present invention can simplify arrangement of an optical switch or design of a waveguide and reduce the optical loss.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An optical switch comprising:
a first coupler branching an optical signal transmitted to a first or second input waveguide into two optical signals;
an optical delay line comprising first and second arm waveguides of the same length transmitting the branched optical signal and a heater heating the first arm waveguide, the first and second arm waveguides having one of a full wavelength optical path difference and a half wavelength optical path difference according to whether the heater is turned on; and
a second coupler branching optical signals outputted from the optical delay line into two optical signals, respectively, and transmitting the branched optical signals to the first or second output waveguide.

2. The optical switch of claim 1, wherein the first coupler, the second coupler, and the optical delay line are configured with one Mach-Zehnder interferometer.

3. The optical switch of claim 2, wherein the optical delay line has the half wavelength optical path difference when the heater is turned off, and has the full wavelength optical path difference when the heater is turned on.

4. The optical switch of claim 3, wherein the first arm waveguide comprises a first portion, and the second arm waveguide comprises a second portion corresponding to the first portion, the first portion having a width smaller than that of the second portion.

5. The optical switch of claim 4, wherein the heater heats the first portion directly.

6. The optical switch of claim 3, wherein the optical signal inputted to the first or second input waveguide is outputted in a straight state when the heater is turned on.

7. The optical switch of claim 3, wherein the optical signal inputted to the first or second input waveguide is outputted in a cross state when the heater is turned off.

8. The optical switch of claim 7, wherein the first output waveguide and the second output waveguide cross each other.

9. The optical switch of claim 1, wherein the half wavelength optical path difference is generated according to mechanical processing of the respective first and second arm waveguides.

10. The optical switch of claim 1, wherein the half wavelength optical path difference is generated by a change of the refractive indexes of the respective first and second arm waveguides.

11. The optical switch of claim 1, wherein the half wavelength optical path difference is generated by a change of the width of the respective first and second arm waveguides.

12. An optical switch matrix comprises:
input waveguides coupled to M (M is an integer greater than 1) input ports, respectively;
output waveguides coupled to N (N is an integer greater than 1) input ports, respectively; and
optical switches formed with one Mach-Zehnder interferometer at each position where the input waveguides and the output waveguides cross each other,
wherein the optical switches comprise first and second arm waveguides of the same length generating one of a full wavelength optical path difference and a half wavelength optical path difference according to whether a heater is turned on, and the heater heats the first or second arm waveguide.

13. The optical switch matrix of claim 12, wherein, when an optical signal inputted to one of the input ports is outputted to one of the output ports, the other output ports except the output ports to which the optical signal is outputted are blocked out such that optical signals are not outputted to the other output ports, and the optical switch matrix further comprises dummy output ports for outputting the optical signals.
